(19) United States
(12) Patent Application Publication
(10) Pub. No.: US 2024/0135758 A1
(43) Pub. Date: Apr. 25, 2024

(54) REMOTE VEHICLE COMMUNICATIONS FILTERING

(71) Applicant: REPARIFY, INC., Plano, TX (US)

(72) Inventor: Michael Patrick EDGAR, Plano, TX (US)

(21) Appl. No.: 18/566,300

(22) PCT Filed: May 30, 2022
(86) PCT No.: PCT/US2022/072653

§ 371 Date: Dec. 1, 2023

Related U.S. Application Data
(60) Provisional application No. 63/195,485, filed on Jun. 1, 2021.

(51) Int. Cl. G07C 5/00; H04W 4/40

(52) U.S. Cl. CPC G07C 5/008; H04W 4/40; G07C 2205/02

(57) ABSTRACT

A system for on board diagnostic (OBD) vehicle communications that includes a vehicle communications device having a pin-connector adapted for connecting to a vehicle's OBD system and a network interface configured to perform network communications with a remote communications device connected with a vehicle scan and/or programming tool using a compatible pin-connector. The remote communications device includes a network interface configured to perform network communications with the vehicle communications device. The vehicle communications device is programmed and configured to receive communications from a vehicle's OBD system through its pinconnector and selectively filter communications based on message type received from OBD system. The selectively filtered communications are forwarded through a network to the remote communications device using the network interfaces.

### CROSS-REFERENCE TO RELATED PATENT APPLICATION

This is a utility application based upon and claims priority of application 63/195,485 filed on Jun. 1, 2021. This related application is incorporated herein by reference and made a part of this application. If any conflict arises between the disclosures in this utility application and that in the related provisional application, the disclosure in this utility application shall govern. Moreover, the inventor(s) incorporate herein by reference any and all patents, patent applications, and other documents hard copy or electronic, cited or referred to in this application.

### BACKGROUND

### Field of the Disclosure

The present disclosure relates generally to methods and apparatus that perform vehicle system communications.

### Description of Related Art

On-board diagnostics (“OBD”) systems enable a vehicle owner or technician to access vital information about and program various modules and sub-systems within a vehicle. For many years, manufacturers have included OBD systems in their vehicles. In a traditional repair setting, a technician utilizes a specialized scan tool that is adapted to interface with a given vehicle's OBD system over the vehicle's data link connector (“DLC”). The scan tool is capable of reading data about the vehicle's sub-systems for diagnostic purposes while also enabling some reprogramming of the sub-systems. Typically, these scan tools are stand-alone handheld computing devices connected directly into a vehicle via a cable to its DLC. Numerous standards have been implemented for vehicle diagnostic systems and communication protocols, some mandated for tracking and inspecting such features as emission control. These communication standards include, for example, OBD-1, OBD-II, SAE J2534, SAE J1850 PWM (pulse-width modulation), ISO 15765, and ISO 9141-2. One common standardized feature of OBD systems has become the use of a 16-pin data link connector (“DLC”) located under the dashboard of the vehicle. Many vehicle manufacturers utilize this connection system and have adopted the identified communication standards that are shared with the public for performing basic diagnostics functions.

Many manufacturers also use these same OBD systems to repair and update various advanced computerized systems within a vehicle. There are some diagnostic/programming tools which can utilize personal computers and remote networking systems. A problem with using networked systems, however, is inherent latency associated with network communications. Some vehicle OBD systems are designed by default to communicate within specific timing constraints (e.g., at or near real-time responsiveness) such as with a manufacturer's marketed direct-connect scan/programming tools. A network-caused latency may thus interfere with OBD communications and impede the use of remote tools.

### SUMMARY

Embodiments of the present disclosure include systems and methods for implementing communications between vehicle on board diagnostics (OBD) systems and remote scan/programming tools designed for improving latency in such communications. A communication system includes a vehicle-(or car-)side communications device that is configured to plug into or otherwise connect to an OBD system connector (e.g., DLC) and has a network communications interface for facilitating bi-directional communication between the OBD system and remote network devices. The system also includes a tool-side (or remote) communications device that has a connector which permits a scan/programming tool to plug into the tool-side communications device as if it were the connector to a vehicle's OBD system. The tool-side device also has a network communications interface that facilitates bi-directional remote communications between a connected scan/programming tool and an OBD system connected to a car-side device through its respective network communications interface.

The vehicle-side device is configured to selectively filter/permit communications from the OBD system and forward the selected communications to the tool-side device and connected vehicle tool. As some OBD systems traffic communications not intended for and/or are useful to an external vehicle tool, such filtering may reduce unnecessary network traffic communications and thereby reduce latency caused by such traffic. In some embodiments, a hardware filter in the car-side communications device is configured to filter out communications not identified as diagnostic or generally not used by external vehicle scan/programming tools. The hardware filter may include a mask applied to a standard identification in the (e.g., frame header of) communications that distinguishes/classifies communications between diagnostic and vehicle operational communications, for example.

In some embodiments, a software filter is programmed in the car-side device which filters out communications not responsive to initial communications (e.g., diagnostic requests/programming) sent by the tool through the tool-side communications device to the vehicle-side device. In some embodiments, the vehicle-side device monitors communications from the tool and tracks/stores in memory the identifiers of received request/programming messages. As communications are received from the OBD system, they are compared by the software filter to the stored identifiers and thereafter matching communications are selectively forwarded to the remote communications device while non-matching communications are blocked (not forwarded).

### BRIEF DESCRIPTION OF THE DRAWINGS

Embodiments of the disclosure will be described hereafter in detail with particular reference to the drawings. Throughout this description, like elements, in whatever embodiment described, refer to common elements wherever referred to and reference by the same reference number. The characteristics, attributes, functions, interrelations ascribed to a particular element in one location apply to that element when referred to by the same reference number in another location unless specifically stated otherwise. In addition, the exact dimensions and dimensional proportions to conform to specific force, weight, strength and similar requirements will be within the skill of the art after the following description has been read and understood.

All figures are drawn for ease of explanation of the basic teachings of the present disclosure only; the extensions of the figures with respect to number, position, relationship and dimensions of the parts to form examples of the various embodiments will be explained or will be within the skill of the art after the present disclosure has been read and understood.

FIG. 1 is an illustrative block diagram of vehicle remote communications system according to some embodiments.

FIG. 2A is an illustrative block diagram of a vehicle-side communications device according to some embodiments.

FIG. 2B is an illustrative block diagram of the computing components of a vehicle-side communications device according to some embodiments.

FIG. 3 is an illustrative flow chart of a process for performing remote communications with a vehicle OBD system according to some embodiments.

FIG. 4 is an illustrative flow chart of a process for selectively filtering remote communications from a vehicle OBD system according to some embodiments.

FIG. 5 is an illustrative flow chart of processes between a tool-side communications device and vehicle-side communications device for selectively filtering remote communications according to some embodiments.

FIG. 6 is an illustrative flow chart of a process for configuring a software filter for communications in a remote communications system according to some embodiments.

FIG. 7A is an illustrative flow chart of a process for filtering segmented communications in a remote communications system according to some embodiments.

FIG. 7B is an illustrative flow diagram of a process for filtering messages utilizing a segmented address protocol according to some embodiments.

FIG. 7C is a table of parameters for a protocol implementing extended addressing according to ISO 15765.

### DETAILED DESCRIPTION OF THE INVENTION

In order that embodiments of the disclosure may be clearly understood and readily carried into effect, certain embodiments of the disclosure will now be described in further detail with reference to the accompanying drawings. The description of these embodiments is given by way of example only and not to limit the scope of the disclosure. It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

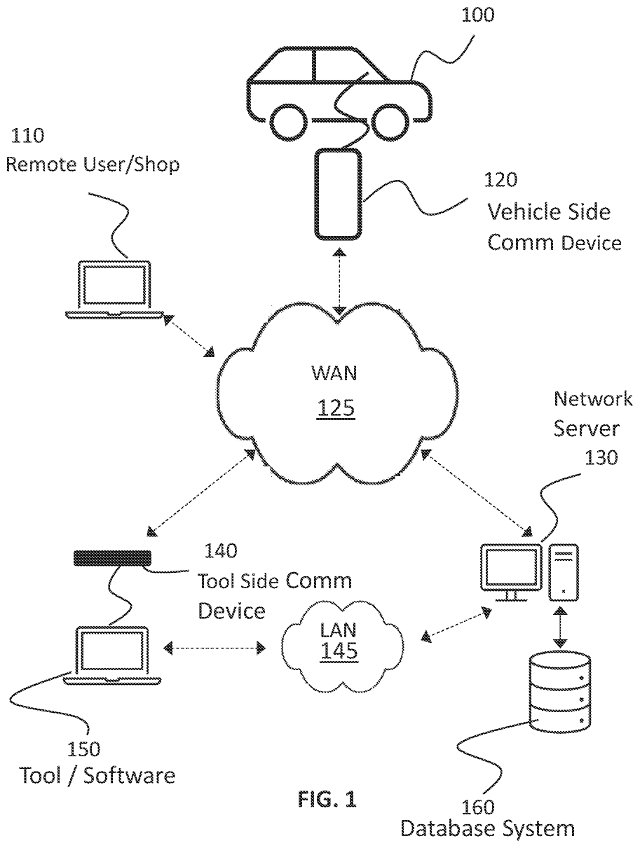

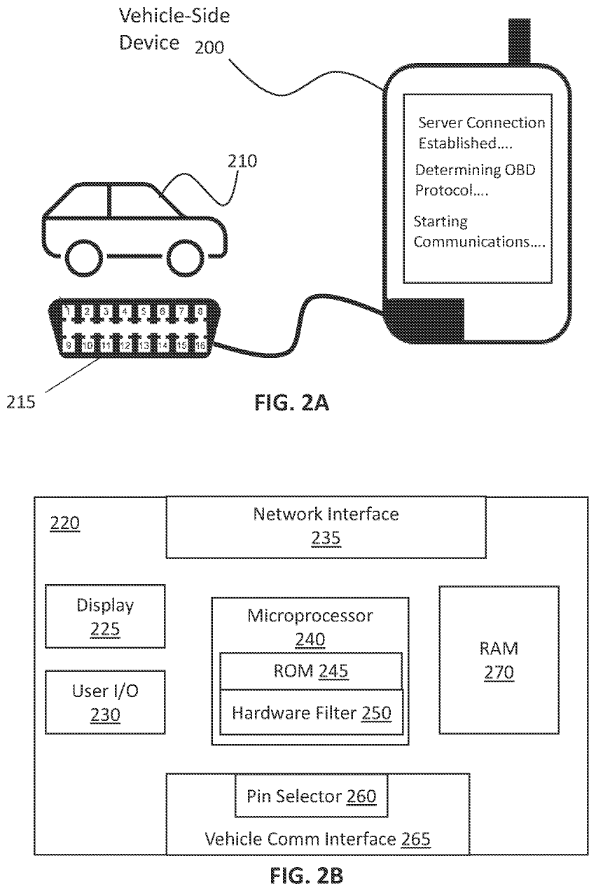

FIG. 1 is an illustrative block diagram of vehicle remote communications system according to some embodiments. A vehicle-side communications device 120 is connected to the on-board diagnostics (OBD) system of a vehicle 100. In some embodiments, the vehicle-side communications device 120 is connected through a built-in connector (e.g., 16-pin connector 215 of FIG. 2A) of vehicle 100. The vehicle-side communications device 120 is further connected to a wide-area network (WAN) 125 (e.g., the internet) such as through a network adapter. A diagnostics/programming tool 150 (i.e., a “scan tool”) is connected to a tool-side communications device 140 that is further connected to WAN 125.

Tool 150 may be a computer installed with diagnostics/programming software configured to perform diagnostics/programming on a vehicle (e.g., vehicle 100) through a vehicle's OBD system. Tool 150 may be a tool system (e.g., a networked system of computers/devices) that includes multiple tools configurable/selectable for use with multiple types of vehicles. Tool 150 may also be a dedicated (e.g., mobile/hand-held) scan tool. The device and/or software may be authorized/produced by the vehicle's manufacturer (e.g., an OEM scan tool) and designed to establish a direct/local bi-directional connection with the vehicle (e.g., directly through a built-in OBD connector). A network server 130 and an associated database system 160 may be connected through a local area network (LAN) 145 and/or WAN 125 to assist with operation/updating of tool 150, the vehicle-side communications device 120, and/or tool-side communications device 140. Database system 160 may be configured for distribution/maintenance of configurations and/or tools for performing diagnostics/programming on a wide variety of makes/models of vehicles and their OBD systems.

Tool-side device 140 and vehicle-side device 120 are configured to communicate with each other and thereby facilitate communications between tool 150 and the OBD system of vehicle 100. In some embodiments, a connection between tool side device 140 and vehicle side device 120 is used to simulate or mimic a direct-wired connection between vehicle 100 and tool 150. In some embodiments, communications received from the OBD system by the vehicle side device are filtered to identify applicable/permissible and/or unnecessary/inapplicable communications (e.g., not intended or necessary for the tool 150 to operate) before forwarding applicable communications to the tool, thereby improving efficiency in communications across a WAN.

In some embodiments, additional remote devices (e.g., remote device 130) may be used to operate, configure, and/or communicate with tool-side device 140, tool 150, server 170/database system 160, vehicle-side communications device 120, and/or vehicle 100 through WAN 125 and/or LAN 145. For example, a remote vehicle shop may use a device 110 to facilitate/observe a remote programming/diagnostics session between tool 150 and vehicle 100.

FIG. 2A is an illustrative block diagram of a vehicle-side communications device according to some embodiments. Vehicle side device 200 is configured to communicate with vehicle 210 such as through the vehicle's OBD system, effectively read the communications from the OBD system and forward them to a tool side device (e.g., tool-side device 140 of FIG. 1). Vehicle side device may include a cable and connector 215 adapted to directly plug into a vehicle's OBD connector (e.g., a standardized 16-pin connector). The vehicle's OBD system may communicate signals through the connector 215, conveying both communications between internal systems of the vehicle and those directed to external programming/scan tools (e.g., tool 150).

FIG. 2B is an illustrative block diagram of the computing components of a vehicle-side communications device according to some embodiments. Computing components 220 includes a microprocessor 240, display 225, and input circuitry 230. Microprocessor 240 in turn includes read only memory (ROM) 245 and a hardware communications filter 250 which is used to filter communications received through a vehicle communications interface 265.

Vehicle communications interface 265 may include an OBD connection interface (e.g., for connecting through a cable and connector 215). Vehicle communications interface 265 may include a pin selector 260 which activates/deactivates communication through particular pins (e.g., 1 through 16 as shown in connector 215), which may be configured to correspond with the pins used by a particular vehicle/OBD system being communicated with. In some embodiments, the pin selector is configured based on information (e.g., a database with records of VINs and pin configurations) for connecting with the particular vehicle 210. A network interface 235 is utilized to communicate with other systems through a network (e.g., across WAN 125), including with a remote tool-side communications device (e.g., tool side device 140) and further with a connected programming/diagnostics tool (e.g, of tool 150 of FIG. 1).

When receiving communications from a vehicle/OBD system, hardware filter 250 may be applied to the received communications and restrict forwarding of messages to those for use by a remote tool (e.g., tool 150). Hardware filter 250 may include applying hardware-based masks that indicate whether received communications are applicable to the remote tool. The hardware filter may be used to eliminate communications identified as inapplicable to diagnostic and/or programming functions of the vehicle, for example.

In some embodiments, masks may be applied in a hardware lookup table such as a ternary content addressable memory (TCAM) table and applied to a header and/or identification segment of a received message/packet. The masks may limit communications based on a particular priority range or threshold (as identified in an identifiable communication parameter) such as those with a priority level indicating a high-level vehicle inter-system communication (e.g., from a steering wheel to a steering mechanism) that would not typically be intended for use by a remote tool.

Microprocessor 240 may also be programmed with a software-based filter to further restrict communications intended for a remote tool. The program may reside in a random access memory (RAM) for execution, loaded from a storage device (e.g., external drive, cloud), and executed by one or more processors (e.g., processor 240). The program may be configured to monitor messages from a tool (e.g., tool 150), track identifiers/parameters included in the messages (e.g., storing them in RAM 270), later comparing/pairing them to the parameters of messages from the vehicle OBD system (e.g., from vehicle 210), and not forwarding those messages from the vehicle which are not paired.

A computer display 225 (e.g., as shown in device 200) may be used to provide status messages about the communications process and/or other information. User input/output (I/O) 230 (e.g., mouse, keyboard) may be used by an operator to control the vehicle communications device 200 such as to initiate communications, select parameters, and/or perform/program other operations. In some embodiments, computer display 225 operates as an I/O device (e.g., a touchscreen).

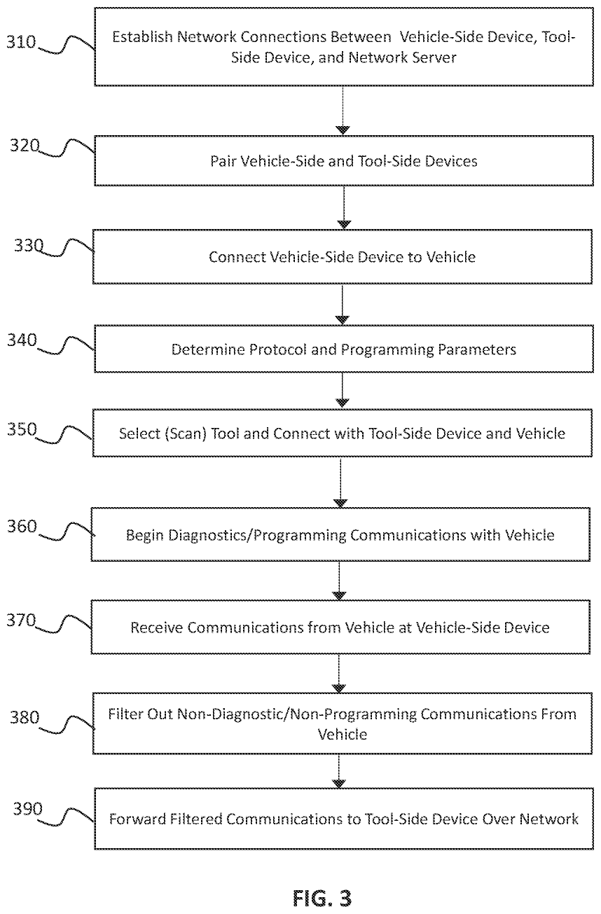

FIG. 3 is an illustrative flow chart of a process for performing remote communications with a vehicle OBD system according to some embodiments. At block 310, network communications start to be established between a vehicle side communications device (e.g., vehicle-side device 120 of FIG. 1), a tool side communications device 140, and, in some embodiments, a network server (e.g., network server 130 of FIG. 1). At block 320, the vehicle side and tool side devices are paired with each other and are configured to identify received communications as being from each other.

A network server (e.g., server 130) may facilitate a selection of the pairing and/or establishing communications between the communications devices by identifying the vehicle side communications device based on an identification associated with the vehicle-side device and/or vehicle OBD system (e.g., using a built-in ID such as a VIN) and utilizing a look-up table in a database (e.g., through database system 160) with records of such identifications and associated configuration parameters and/or tools (e.g., compatible tool-types, communication protocols).

At block 330, the vehicle-side device is connected (if not already) to the vehicle. This connection may be through a cable and OBD connector (e.g., connector 215 of FIG. 2A) to an OBD system of a vehicle. In some embodiments, the connection through a vehicle OBD system connects the vehicle-side device with the controller area network (CAN) of the vehicle, which may also transmit internal messages between various sub-systems of the vehicle and which are not applicable to performing vehicle diagnostics/programming with the selected remote tool.

At block 340, protocol and/or programming parameters for communicating with the vehicle OBD system are determined. This may be performed by utilizing information about the vehicle and records in a database (e.g., based on a lookup using a VIN) as referenced above with respect to block 320. In some embodiments, information about protocol/parameters are obtained by “listening” to communications from the OBD system and identifying markers within the communications (e.g., message structure/contents) and/or monitoring the communications speed. For example, the bit-rate of an OBD system may be determined such as described in related U.S. patent application entitled “Remote Vehicle Communications Bitrate Determination” having Attorney Docket Number RPFY-PT/US-09437, the entire contents of which is herein incorporated by reference.

At block 350, a diagnostics/programming tool is selected and/or configured (if not already during the process) and connected with the vehicle OBD system through the tool-side and vehicle-side communications devices over a network. The tool selection/configuration may be based, at least on part, on the protocol/programming parameters determined at block 340. The tool may be a software-based tool installed on a remote computer/server/system among numerous other tools from which it is selected. The tool may also be a stand-alone tool with its own built-in processing/connector components. The tool may be configured to perform diagnostics and/or programming through vehicle OBD systems. The tool may be configured to normally operate through a direct “wired” connection with a vehicle OBD system such as from an OBD cable/connector integrated with the tool (e.g., a connector similar to cable/connector 215 of FIG. 2A) that is directly wired with an OBD connector of a vehicle (e.g., a data link connector (DLC) typically found under the dashboard of a vehicle).

At block 360, after selecting/connecting the tool with the tool side communications device, the tool is used to begin performing diagnostics and/or programming on the vehicle through the connections between the tool side communications device, vehicle side communications device, and vehicle OBD system. Communications received from the tool at the tool side communications device are thereby forwarded to the vehicle OBD system. In some embodiments, communications received from the tool are analyzed to determine their type and other identifying features/parameters (e.g., as parts of diagnostic/programming-type messages and/or applicable tool-vehicle exchanges). In some embodiments, these identifying features/parameters of the communications are stored in computer memory (e.g., in the memory of the tool side and/or vehicle side communications devices).

At block 370, communications are received from the vehicle OBD system at the vehicle side communications device, such as communications that are responsive to the communications from the tool. At block 380, these communications received from the vehicle OBD system are processed to filter out communications not applicable to use by the tool. In some embodiments, the communications are initially processed/eliminated using a hardware filter (e.g., hardware filter 250 of FIG. 1). The hardware filter may be configured to identify communications identifiable as not being applicable to remote programming/diagnostic tools. For example, an identification parameter within the communications may identify them as high priority communications dedicated for vehicle inter-system use. After communications identified by a hardware filter are eliminated, remaining communications may be further processed by a software filter.

In some embodiments, a software filter is implemented to process communications and eliminate communications not applicable to use by the tool. The software filter may be programmed to identify communications related/responsive to those communicated from the OBD system pursuant to the analysis described with respect to block 360. For example, certain parameters of the communications may be correlated (e.g., by an ID parameter) with a response to a particular diagnostic/programming request communicated by the tool. Those communications not identified as related/responsive may be eliminated/omitted according to some embodiments.

In some embodiments, the software filter is programmed based on “pairing” the tool side communications device and vehicle side communications device. After a connection is made between the devices, the software filter on the vehicle side device is reset and begins a “listening mode” in which communications coming from the vehicle are monitored for a predetermined amount of time (e.g., about 5 seconds) before a remote tool/vehicle communications session commences. In some cases, a vehicle will transmit non-diagnostic/tool communications regardless of whether a tool is connected or communicating with the vehicle. Identifying parameters from these communications during the listening mode are stored for the software filter to use for filtering out inapplicable communications.

At block 390, those communications not filtered out at block 380 are forwarded by the vehicle side communications device to the tool side communications device over a network (e.g., WAN 125). In some embodiments, the messages are first converted to and encapsulated within packets (e.g., TCP/IP packets) compatible with the network (e.g., a TCP/IP network) before they are forwarded over the network to the tool side communications device. After receipt by the tool side device, those forwarded packets containing the messages may be re-converted to a format compatible with the tool (e.g., pin signals compatible with an OBD connector between the tool and tool side device) before they are forwarded to the tool.

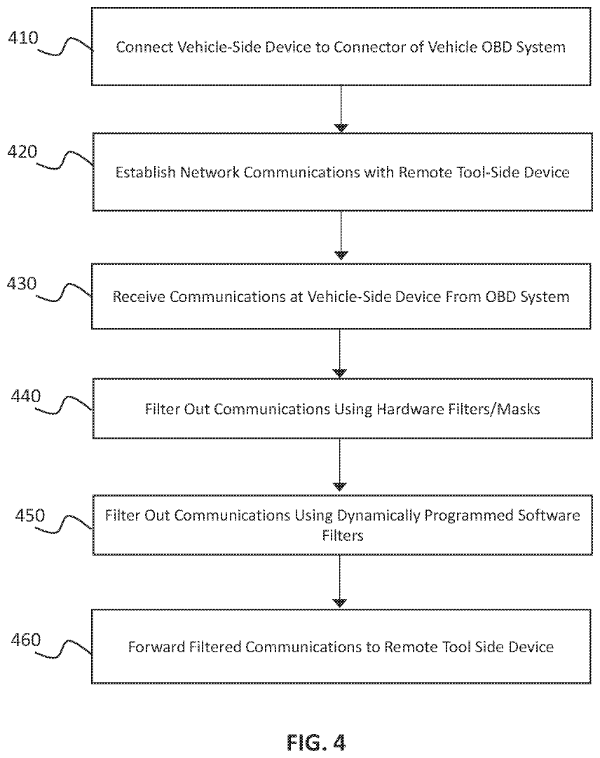

FIG. 4 is an illustrative flow chart of a process for selectively filtering remote communications from a vehicle OBD system according to some embodiments. At block 410, a vehicle side communications device (e.g., device 200 of FIG. 2 and device 120 of FIG. 1) is connected to a vehicle's OBD system. In some embodiments, the connection is facilitated through a pin-based OBD connector with a vehicle's connector (e.g., a DLC).

At block 420, network communications (e.g., over a WAN network 125) are established between the vehicle side communications device and tool side communications devices. In some embodiments, the tool side communications device receives communications from the tool (e.g., programming/diagnostic messages). In some embodiments, these communications are monitored by the tool side and/or vehicle side communications devices to track types and particular parameters of the communications.

At block 430, communications are received by the vehicle-side device from the vehicle's OBD system. These communications may be unrelated to performing diagnostic/programming tasks such as vehicle inter-system communications. At block 440, these communications are processed by a hardware filter in the vehicle side communications device (e.g., hardware filter 250 of FIG. 2B) that identifies communications which are not likely applicable to use by an external diagnostics/programming tool. The hardware filter may include a hardware table with entries/masks (e.g., a TCAM table) that may be applied to message parameters (e.g., from message headers/data) that identify the messages by type and/or priority. For example, an identified priority level that exceeds a particular value may be indicative of inapplicable non-diagnostic inter-system message. Those messages which are identified by the filter as inapplicable may be omitted from being forwarded to the remote tool side communications device over the network.

At block 450, a software filter is applied to the communications received from the OBD system such as those communications not already omitted by the hardware filter. In some embodiments, the software filter is dynamically configured such as based on the monitoring performed at block 420. For example, the software filter may be programmed to pair incoming communications from the OBD system with those received from the tool using stored information about the tool's communications (e.g., message type, message ID). Communications from the vehicle OBD system that are not successfully paired using the software filter may be omitted from being forwarded to the tool side communications device.

At block 460, the communications not filtered out by the hardware filter at block 440 or software filter at block 450 are forwarded by the vehicle side communications device to the tool side communications device. These communications may be converted to a network compatible format prior to forwarding across the network between the communications devices.

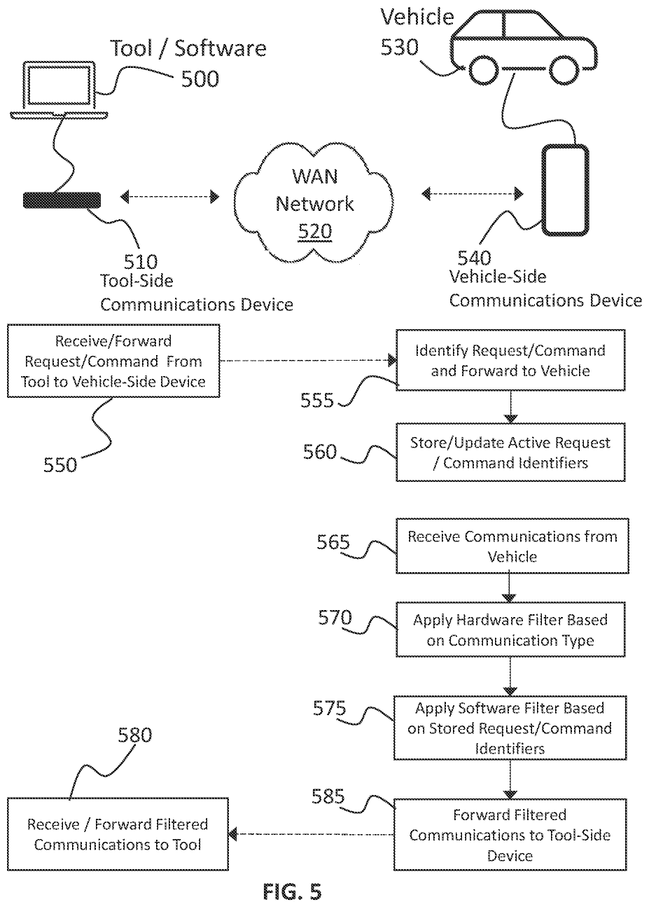

FIG. 5 is an illustrative flow chart of processes between a tool side communications device and vehicle side communications device for selectively filtering remote communications between a vehicle and tool according to some embodiments. A diagnostics/programming tool 500 and the internal communications network (e.g., controller area network (CAN), OBD system) of a vehicle 530 are connected over a wide area network (WAN) 520 through a tool side communications device 510 and vehicle side communications device 540, each of which are respectively locally connected (e.g., wire/LAN) to the tool and vehicle. The tool side communications device 510 and vehicle side communications device 540 may be paired with each other and one or more unique identifiers corresponding to each other and/or their connection (e.g., device ID, remote connection/session ID) may be established/shared/stored and thereby accessible by each of the devices while they are connected.

Various processes of the tool side and vehicle side communications devices are represented for each device and with respect to each other. At block 550, the tool side communications device receives a request/command from tool 500 directed to the vehicle. The request/command may be, for example, a request for diagnostic information from the vehicle such as, for example, the status of the vehicle's emission system, braking system, steering system, maintenance status, etc.). In some embodiments, the request/command is a request/command to program/update a particular system of the vehicle (e.g., navigation system, driver-assist system, etc.). The request/command is forwarded to the vehicle side communications device over WAN 520, where the communication is analyzed by the vehicle side communications device at block 555.

At block 555, a communication received from the tool 500 and tool side communications device 510 are analyzed to identify the type, category, and/or source device of the communication. This information may be contained within the message (e.g., a message header). The information may include a parameter that identifies the communication as a particular type of diagnostics/programming request and/or a unique identifier of the tool and/or tool-side communications device. At block 560, after identifying the information, the vehicle side device 540 (and/or another connected device) may store at least a portion of the information in computer memory for later use. This information may be dynamically updated while the tool side and vehicle side devices are connected and additional communications are received from tool 500.

At block 565, a communication is received by the vehicle side communications device 540 from the vehicle 530. At block 570, a hardware filter such as described further herein is applied to the communication by which the communication may be ignored/omitted if it is not applicable for use by a diagnostics/programming tool. If the communication is not omitted by the hardware filter, a software filter is applied to the communication at block 575. The software filter may analyze the communication and determine whether it matches with information stored at block 560 (e.g., message type, device ID/session ID(s)). If the communication does not match, the communication may be omitted/eliminated from being forwarded to the tool side communications device 510.

At block 585, communications that have not been filtered out by the software or hardware filters are forwarded across WAN 520 between vehicle side device 540 and tool side device 510. These communications may first be converted into packets compatible with transmission across WAN 520 before being converted to communications compatible with tool 500. At block 580, packets received from vehicle side device 540 at tool side device 510 are re-converted from packets to communications compatible with tool 500 (e.g., in a format as originally received from vehicle 530). After re-converting, the communications are transmitted to tool 500 from tool side device 510, such as through a cable and pin-based OBD connector connected to tool 500).

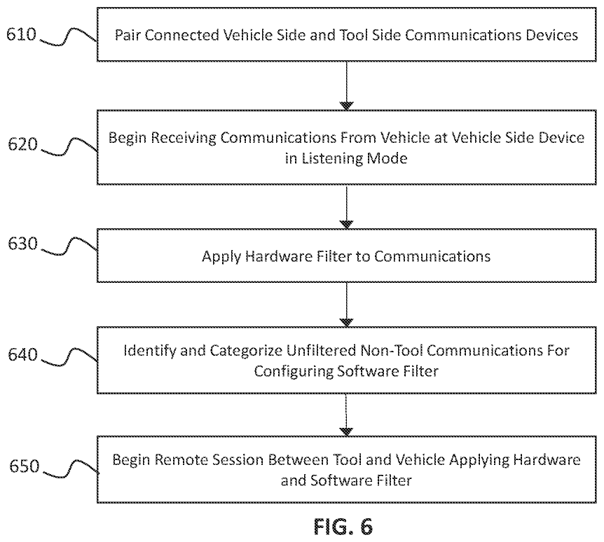

FIG. 6 is an illustrative flow chart of a process for configuring a software filter for communications in a remote communications system according to some embodiments. At block 610, a vehicle side communications device (e.g., device 120 of FIG. 1) and a tool side communications device (e.g., device 140 of FIG. 1) are paired for facilitating a remote vehicle/tool diagnostics/programming session. At block 620, after pairing the vehicle side and tool side devices, a software communications filter is reset to filter communications received from the vehicle side communications device from the vehicle. In some embodiments, the reset configures the software filter to accept all messages for forwarding (e.g., that are not omitted/excluded by a hardware filter such as described herein).

After the reset of the software filter, the vehicle side communications device starts a “listening mode” by monitoring communications from the vehicle for a predetermined period of time. The vehicle may communicate messages during the listening mode not used for external tools (e.g., diagnostic messages). At block 630, a hardware filter omits/filters messages from being forwarded.

At block 640, after being filtered by the hardware filter, the software filter is configured during the listening mode so that it may filter out additional such communications not applicable to the tool. For example, the messages may be identified by a message ID and the software filter configured (e.g., in a computer memory data array/lookup table) to ignore future messages including the same ID as those received during the listening mode.

At block 650, a remote session is started between the tool and vehicle and facilitated by the vehicle side and tool side communications device such as described herein. In some embodiments, the software filter may be further updated dynamically during the session such as based on parameters from communications received from the tool as further described herein.

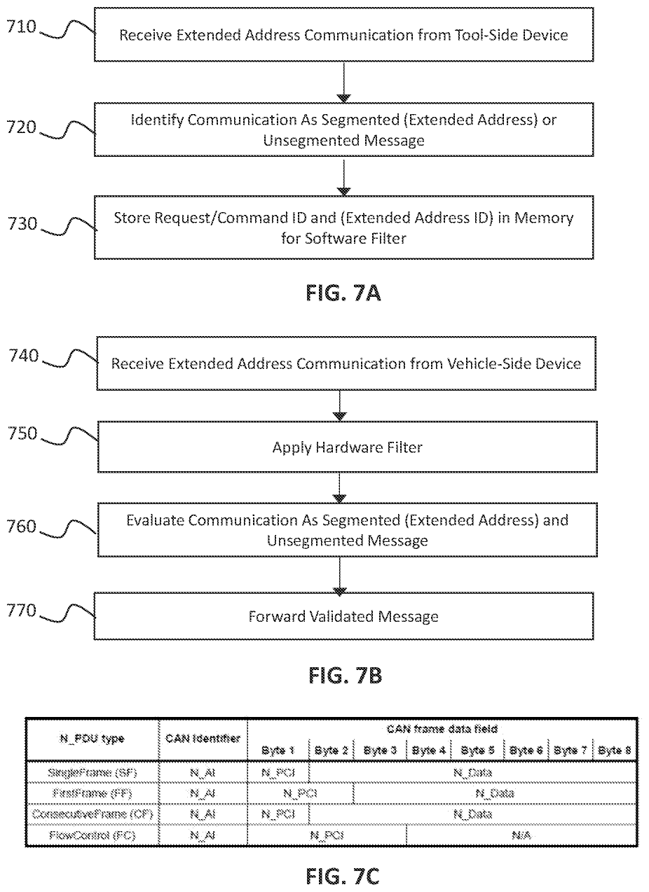

FIG. 7A is an illustrative flow chart of a process for filtering segmented communications in a remote communications system according to some embodiments. In some embodiments, messages between a tool and a vehicle include extended/segmented addressing in which the contents of one message is not contained within a single “packet” or frame. For example, many CAN frames used by vehicles/tools are limited to sizes of 8 bytes (e.g., as stipulated by ISO 15765) but some vehicles/tools are designed to communicate multi-frame/segment messages longer than 8 bytes during a remote session. The protocol for communicating these multi-frame messages may utilize an extended addressing protocol (e.g., as illustrated in FIG. 7C). FIG. 7C is a table of parameters for a protocol implementing extended addressing according to ISO 15765.

In some embodiments, extended addressing parameters in messages between a vehicle and tool are utilized by the software filter to assist in determining which messages are forwarded from the vehicle side communications device to the tool side device. This may be performed when it is known that the tool and vehicle implement extended addressing protocols (e.g., complying with ISO 15765 such as shown in FIG. 7C).

At block 710, a communication from the tool is received and monitored by a vehicle side communications device. The communication is first evaluated at block 720 as an unsegmented message and then as a segmented message to determine which type of message has been received. For example, a service identifier byte(s) (e.g., bytes 2 or 2 and 3) of a CAN frame is analyzed as an unsegmented and segmented message to determine if it is consistent with vehicle-tool communications (e.g., that includes proper/known identifiers and/or other message parameters). The message identifier and its type are then stored in memory for use by the software filter at block 730. The software filter may then be utilized to identify messages following the particular protocol with the particular identifiers for forwarding from the vehicle to the tool.

FIG. 7B is an illustrative flow diagram of a process for filtering messages utilizing a segmented address protocol according to some embodiments. At block 740, an extended address message is received from a vehicle at a vehicle side communications device. At block 750, a hardware filter is applied to the message such as further described herein. At block 760, the communication, if not eliminated/filtered by the hardware filter, is further evaluated by the software filter and its contents compared/validated with parameters for consistency/correlation with messages received from the tool (e.g., evaluated as described in reference to FIG. 7A).

The message may first be evaluated as both an unsegmented message and segmented message to determine which type of message it is and then compared with identifiers programmed for use by the software filter. At block 770, messages that match (i.e., validated) with the programmed identifiers are then forwarded from the vehicle side communications device to the tool side communications device and to the tool.

In some embodiments, the tool side communications device is programmed to forward messages to the tool in the same sequential order that they were received by the vehicle side device from the vehicle. The correct sequential order may be determined such as by analyzing the parameters of a segmented address protocol message that enumerates the order in a multi-segmented response. The vehicle side device may forward information to the tool side device such as validated identifier/extended address information. The tool side device may utilize this information to analyze multi-segmented extended address messages and use the analysis to forward them to the tool in the correct order (e.g., based on an order identified in message contents).

In some embodiments, the vehicle side device tracks the order in which messages are received from the vehicle and/or tool and encapsulates the order in network packets sent from the vehicle side device to the tool side device and/or vice versa. The tool side device/vehicle side device then uses the identified order in the packets to forward messages (e.g., CAN frames) to the tool/vehicle in the order they were received from the vehicle/tool. In some embodiments, in order to forward messages to the tool/vehicle in the received order, the tool/vehicle side devices utilize a semaphore to block out-of-order messages from being forwarded out of turn.

The processes described herein (e.g., the processes of FIGS. 3-7) are not limited to use with the hardware shown and described herein. They may find applicability in any computing or processing environment and with any type of machine or set of machines that is capable of running a computer program. The processes described herein may be implemented in hardware, software, or a combination of the two. The processes described herein may be implemented in computer programs executed on programmable computers/machines that each includes a processor, a non-transitory machine-readable medium or other article of manufacture/media that is readable by the processor (including volatile and non-volatile memory and/or storage elements), at least one input device, and one or more output devices. Program code may be applied to data entered using an input device to perform any of the processes described herein and to generate output information.

The processing blocks (for example, in the processes of FIG. 3-7) associated with implementing the system may be performed by one or more programmable processors executing one or more computer programs to perform the functions of the system. All or part of the system may be implemented as, special purpose logic circuitry (e.g., an FPGA (field-programmable gate array) and/or an ASIC (application-specific integrated circuit)). All or part of the system may be implemented using electronic hardware circuitry that include electronic devices such as, for example, at least one of a processor, a memory, a programmable logic device, and/or a logic gate.

The processes described herein are not limited to the specific examples described. For example, the processes of FIGS. 3-7 are not limited to the specific processing orders illustrated. Rather, any of the processing blocks of FIGS. 3-7 may be re-ordered, combined or removed, performed in parallel or in serial, as necessary, to achieve the results set forth above.

Elements of different embodiments described herein may be combined to form other embodiments not specifically set forth above. Various elements, which are described in the context of a single embodiment, may also be provided separately or in any suitable sub-combination. Other embodiments not specifically described herein are also within the scope of the following claims.

I claim:

1. A method of remote communications with an on-board diagnostics (OBD) system of a vehicle, the method comprising:
connecting a vehicle communications device to a connector of a vehicle's OBD system;
connecting a remote communications device to a connector of a vehicle tool device;
establishing a network communications link between the vehicle-communications device and a remote communications device;
receiving communications at the vehicle-communications device from the vehicle's OBD system through the connector;
selectively filtering communications based on message type received from OBD system;
based on the filtering, forwarding the communications to the remote communications device through the network communications link; and
forwarding the filtered communications received at the remote communications device to the vehicle tool device.

2. The method of claim 1 wherein selectively filtering comprises:
applying a hardware filter to the communications that selectively permits vehicle diagnostics messages that are identified as distinct from vehicle operational messages;
after applying the hardware filter, applying a dynamically programmable software filter to the communications, wherein the software filter selectively permits communications that are identified as responsive to a request or command received from the remote communications device.

3. The method of claim 1 wherein selectively filtering comprises classifying the communications as diagnostics messages that are distinct from vehicle operational messages.

4. The method of claim 3 wherein the classifying is based on an identifier in the communications identifying a priority level of the communications.

5. The method of claim 1 wherein selectively filtering comprises applying a hardware filter to the communications.

6. The method of claim 5 wherein the hardware filter comprises applying a hardware mask parameter that selects communications for forwarding.

7. The method of claim 6 wherein applying the hardware mask selects communications having an identifier that falls within particular priority value thresholds.

8. The method of claim 1 wherein selectively filtering comprises applying a dynamically programmable software filter to the communications, wherein the software filter identifies communications responsive to a request or command received from the remote communications device and selects the identified communications for forwarding.

9. The method of claim 8 wherein communications from the remote communications device are analyzed to determine an associated request or command identification parameter, the determined parameter is stored in computer memory, and wherein the software filter compares the stored parameter to communications from the OBD system to identify them as communications responsive to a request or command.

10. The method of claim 9 wherein a sequential ordering is identified within the communications from and by the remote communications device and wherein the communications from the remote communications device are forwarded to the OBD system in the identified sequential order by using a semaphore to block a forwarding of communications out of the sequential ordering.

11. The method of claim 9 wherein the communications from the remote communications device are analyzed to determine whether the communications include an extended address communication and, when the communication is identified as an extended address communication, storing an extended address identifier in computer memory, and wherein the software filter compares the stored extended address parameter to communications from the OBD system to identify them as communications responsive to an extended address request or command.

12. A system for on board diagnostic (OBD) vehicle communications, the system comprising:
a vehicle communications device comprising a first pin-connector adapted for connecting to a vehicle's OBD system and a first network interface configured to perform network communications;
a remote communications device comprising a second pin-connector adapted for connecting to a vehicle tool device and a second network interface configured to perform network communications with the vehicle communications device;
wherein the communications device further comprises one or more processors programmed and configured to cause the vehicle communications device to perform:
receiving communications from a vehicle's OBD system through the first pin-connector;
selectively filtering communications from the vehicle-communications device based on message type received from OBD system; and
forwarding the selectively filtered communications through the first network interface to the second network interface of the remote communications device.

13. The system of claim 12 wherein the vehicle communications device comprises a hardware filter programmed and configured to selectively permit vehicle diagnostics messages that are identified as distinct from vehicle operational messages and wherein the one or more processors are further programmed and configured to cause the vehicle communications device to perform:
after the hardware filter is applied to the communications, applying a dynamically programmable software filter to the communications, wherein the software filter selectively permits communications that are identified as responsive to a request or command received from the remote communications device.

14. The system of claim 12 wherein selectively filtering comprises classifying the communications as diagnostics messages that are distinct from vehicle operational messages.

15. The system of claim 14 wherein the classifying is based on an identifier in the communications identifying a priority level of the communications.

16. The system of claim 12 wherein selectively filtering comprises applying a hardware filter to the communications.

17. The system of claim 16 wherein the hardware filter comprises applying a hardware mask parameter that selects communications for forwarding.

18. The system of claim 16 wherein applying the hardware mask selects communications having an identifier that falls within particular priority value thresholds.

19. The system of claim 12 wherein selectively filtering comprises applying a dynamically programmable software filter to the communications, wherein the software filter identifies communications responsive to a request or command received from the remote communications device and selects the identified communications for forwarding.

20. The system of claim 19 wherein communications from the remote communications device are analyzed to determine an associated request or command identification parameter, the determined parameter is stored in computer memory, and wherein the software filter compares the stored parameter to communications from the OBD system to identify them as communications responsive to a request or command.

21. The system of claim 20 wherein a sequential ordering is identified within the communications from and by the remote communications device and wherein the communications from the remote communications device are forwarded to the OBD system in the identified sequential order by using a semaphore to block a forwarding of communications out of the sequential ordering.

22. One or more non-transitory storage media storing instructions which, when executed by one or more computing devices, cause performance of:
establishing a network communications link between a vehicle-communications device and a remote communications device, wherein the vehicle communications device is configured to be connected to a connector of a vehicle's on-board diagnostics (OBD) system, and wherein the remote communications device configured to be connected to a connector of a vehicle tool device;
receiving communications at the vehicle-communications device from the vehicle's OBD system through the connector;
selectively filtering communications based on message type received from OBD system;
based on the filtering, forwarding the communications to the remote communications device through the network communications link; and
forwarding the filtered communications received at the remote communications device to the vehicle tool device.

23. The one or more non-transitory storage media of claim 22 which, when executed by one or more computing devices, further cause the performance of:
applying a hardware filter to the communications that selectively permits vehicle diagnostics messages that are identified as distinct from vehicle operational messages;
after applying the hardware filter, applying a dynamically programmable software filter to the communications, wherein the software filter selectively permits communications that are identified as responsive to a request or command received from the remote communications device.

24. The one or more non-transitory storage media of claim 23 wherein selectively filtering comprises classifying the communications as diagnostics messages that are distinct from vehicle operational messages.

25. The one or more non-transitory storage media of claim 22 wherein the classifying is based on an identifier in the communications identifying a priority level of the communications.

26. The one or more non-transitory storage media of claim 24 wherein selectively filtering comprises applying a hardware filter to the communications.

27. The one or more non-transitory storage media of claim 26 wherein the hardware filter comprises applying a hardware mask parameter that selects communications for forwarding.

28. The one or more non-transitory storage media of claim 22 wherein applying the hardware mask selects communications having an identifier that falls within particular priority value thresholds.

29. The one or more non-transitory storage media of claim 22 wherein selectively filtering comprises applying a dynamically programmable software filter to the communications, wherein the software filter identifies communications responsive to a request or command received from the remote communications device and selects the identified communications for forwarding.

30. The one or more non-transitory storage media of claim 29 wherein communications from the remote communications device are analyzed to determine an associated request or command identification parameter, the determined parameter is stored in computer memory, and wherein the software filter compares the stored parameter to communications from the OBD system to identify them as communications responsive to a request or command.

31. The one or more non-transitory storage media of claim 30 wherein a sequential ordering is identified within the communications from and by the remote communications device and wherein the communications from the remote communications device are forwarded to the OBD system in the identified sequential order by using a semaphore to block a forwarding of communications out of the sequential ordering.

32. The one or more non-transitory storage media of claim 30 wherein the communications from the remote communications device are analyzed to determine whether the communications include an extended address communication and, when the communication is identified as an extended address communication, storing an extended address identifier in computer memory, and wherein the software filter compares the stored extended address parameter to communications from the OBD system to identify them as communications responsive to an extended address request or command.
